(19) United States
(12) Patent Application Publication
(10) Pub. No.: US 2009/0041287 A1
(43) Pub. Date: Feb. 12, 2009

(54) Custom Earphone

(76) Inventor: Aaron M. Quinlisk, Cascade, CO (US)

Correspondence Address: HANES & SCHUTZ, LLC, 102 SOUTH TEJON ST., SUITE 800, COLORADO SPRINGS, CO, 80903, US

(21) Appl. No.: 12/182,011

(22) Filed: Jul. 29, 2008

Related U.S. Application Data
(60) Provisional application No. 60/964,240, filed on Aug. 10, 2007.

(51) Int. Cl. H04R 1/10

(52) U.S. Cl. 381/380

(57) ABSTRACT

The present invention relates to an apparatus and method of fabricating a custom-fit earphone in which a durable flexible earpiece or retainer is molded by the user to the individual shape of their outer ear and cures to adhere and become a permanent integrated unit with a sound transducer such as an earbud.

### RELATED APPLICATIONS

This application claims the benefit of U.S. Provisional Patent Application Ser. No. 60/964,240, filed on Aug. 10, 2007.

### BACKGROUND OF THE INVENTION

(1) Field of the Invention

The present invention relates to an in-the ear custom-fit earphone that is fabricated in-situ by the user.

(2) Description of the Related Art

With the increasing popularity of personal portable music devices and hands-free headsets, audio earphones, headphones without the cumbersome headband and having an in-ear design to more effectively direct soundwaves into the ear canal and block out ambient noise, are also becoming increasingly popular. There are a variety of different types of earphones including: forms that clip around or over the posterior edge of the helix of the outer ear or auricle in order to hold the speaker as close to the ear canal as possible (i.e. U.S. Pat. No. 7,123,737); earbuds that fit just inside the cavity of the auricle at the edges of the ear canal (i.e. U.S. Pat. No. 6,810,987); canalphones having an even smaller speaker size than earbuds and designed with soft ear-tips to fit inside the ear canal (i.e. U.S. Pat. No. 7,212,646).

However, each of these types of earphones is mass-produced resulting in a generic fit. Due to the complex shape of the outer ear or auricle, and individual differences in physiology, the generic fit of mass-produced earphones is often uncomfortable and ill-fitting. Additionally, shifting, failing out, discomfort, and failure to effectively direct sound into the ear canal are common problems experienced with mass-produced earphones, especially at higher activity levels.

The alternative to mass-produced headphones is custom-fitting. This method, established by the Audiology profession, utilizes a custom earmold, similar to a hearing aid earmold. The earmold is typically created from an impression of the user's ear taken by an audiologist and is fabricated at an earmold laboratory. For instance, U.S. Pat. No. 7,387,187 claims a ‘custom-molded earplug,’ formed by processes similar to those of professionally-fabricated hearing aids, disclosing a process for digitizing the shape of the inner ear and then the plug is built up by an additive process. Fit and acoustic delivery are vastly improved over standard earphones. This method solves the problems of generic-shaped, mass-produced earphones, but requires the time and expensive services of a hearing professional; a cost and inconvenience that exceeds the benefits for the typical earphone user.

Custom-fitting in-situ has only found its way into other limited applications with different fabrication and fitting processes, but these processes are not as simplistic or user-friendly as the present invention. For instance, U.S. Pat. No. 5,321,757 discloses a hearing aid formed in-situ, but the fabrication process involves an injection mold, and the fitting process or ‘final processing’ requires several steps.

Accordingly it is the primary objective of the present invention to provide a custom-fit earphone kit that can be fabricated by the user in-situ in a simplistic and cost-effective manner.

A second objective of the present invention is to provide a custom-fit earphone in which the finished earpiece and earphone will be a singular unit, permanently combined.

Another objective of the invention is to provide a method of fabricating a custom-fit earphone in which the earpiece is contoured to match the outer ear of the individual user.

Yet another objective of the invention is to provide a custom-fit ear phone that molds to the shape of the cymba of the concha of the auricle and behind the crus of the helix of the ear in order to form a hook-like structure matching the outer ear physiology of the user and allowing the earphone to remain securely in place even during increased levels of activity.

Other and further objects, features and advantages of the custom earphone of the present invention will become apparent upon a reading of the following description of a preferred form of the invention.

### SUMMARY OF THE INVENTION

The method, kit and apparatus of the present invention relate to custom-fit earphones fabricated in-situ by the end user. The user is provided with all necessary instructions and component parts to produce a finished custom earphone including: molding compound, hardening agent and in-ear sound transducers or speakers covered in a substrate suitable for bonding with the molding compound. These components may then be utilized to form custom-fit earphones in which the in-ear speaker and molded earpiece form one permanent integrated unit fitted to the unique contours of the individual user's outer ear.

### DESCRIPTION OF THE DRAWINGS

FIG. 1 is a perspective view of the interior side of a custom earphone, after the fitting and fabrication process has been completed.

FIG. 2 presents the component parts of the custom earphone kit of the present invention.

FIG. 3 is a flowchart illustrating the steps of the custom earphone fitting and fabrication method.

FIG. 4 is a perspective view of the apparatus of the present invention fitted inside the outer ear.

### DETAILED DESCRIPTION OF THE INVENTION

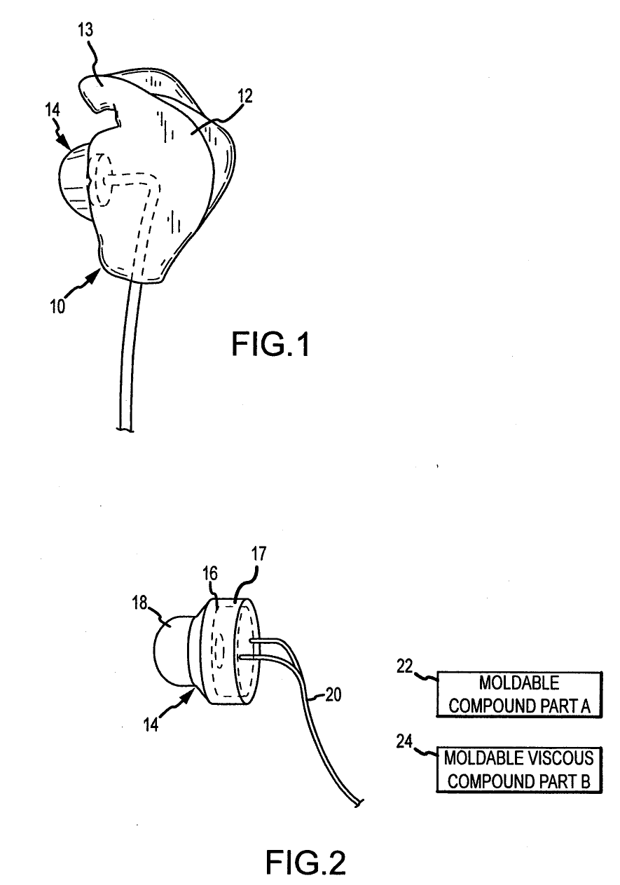

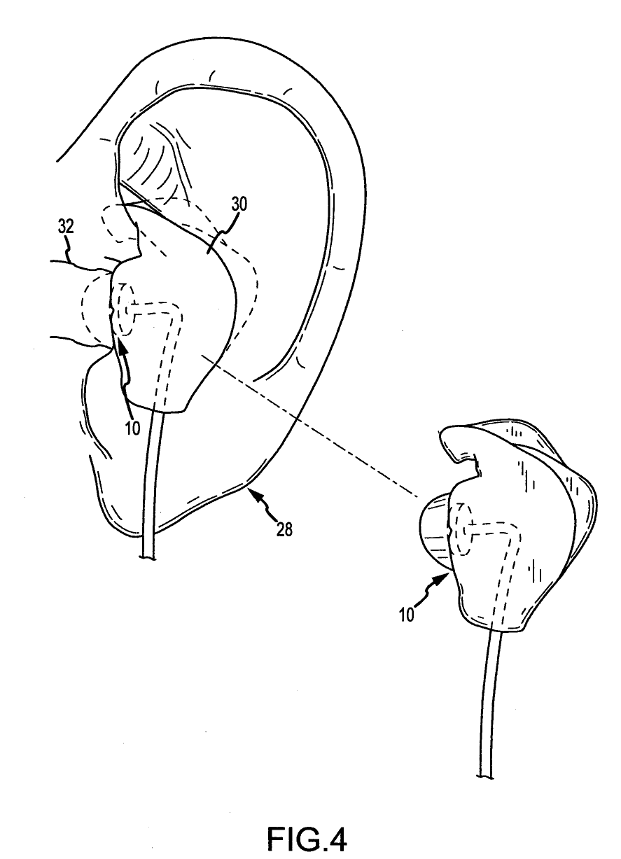

The custom earphone apparatus (10) of the present invention, following completion of the fabrication and fitting process, is depicted in FIGS. 1 and 4. The custom-fitted molded earpiece or retainer (12) is shaped to the contours or concha (cymba and cavity) of the individual user's ear (28) and is permanently integrated with and retains the substrate-mounted sound transducer or speaker assembly (14). The molded retainer is fabricated and custom-fitted in such a way as to result in hook portion (13) being formed to fit the contours of the cymba (one of the concha of the outer ear) of the user. This hook portion (13) rests in the cymba just behind the crus of the helix and assists in the holding the custom earphone in place, even during increased activity levels.

The components of the custom earphone kit of the present invention are depicted in FIG. 2, a speaker assembly (14), and a two-part moldable compound (22, 24). The speaker or sound transducer assembly (14) is comprised of a sound transducer or speaker (16), a substrate mounting for the speaker (17), and may include: a soft-housing (18) for comfortable insertion of the speaker assembly (14) into the external meatus of the ear, and speaker wire (20) extending from the sound transducer assembly to connect to a plug (not shown) for connection to a personal portable audio device or telephone (not shown). The substrate mounting for the speaker has an external surface capable of adhering and bonding with the molding compound such that a permanent integrated structure can result. For instance, the molding compound may be a silicone-based compound, and the external substrate mounting for the speaker may be comprised of a silicone-based material. A silicone-based molding material would have the advantages of curing to a rubber-like material that is both durable and comfortable for use in the outer ear of a user. Moldable Compound Part A (22), a molding material, and Moldable Compound Part B (24), a hardening agent, are viscous substances of a healthcare grade. When the molding material (22) and hardening agent (24) are combined a moldable compound results that may be shaped to the contours of the concha of the user's ear and then subsequently cures and hardens to form a permanent custom-shaped earpiece or retainer (12) which houses the speaker or sound transducer assembly (14), the entire integrated unit being the custom earphone apparatus (10) of the present invention.

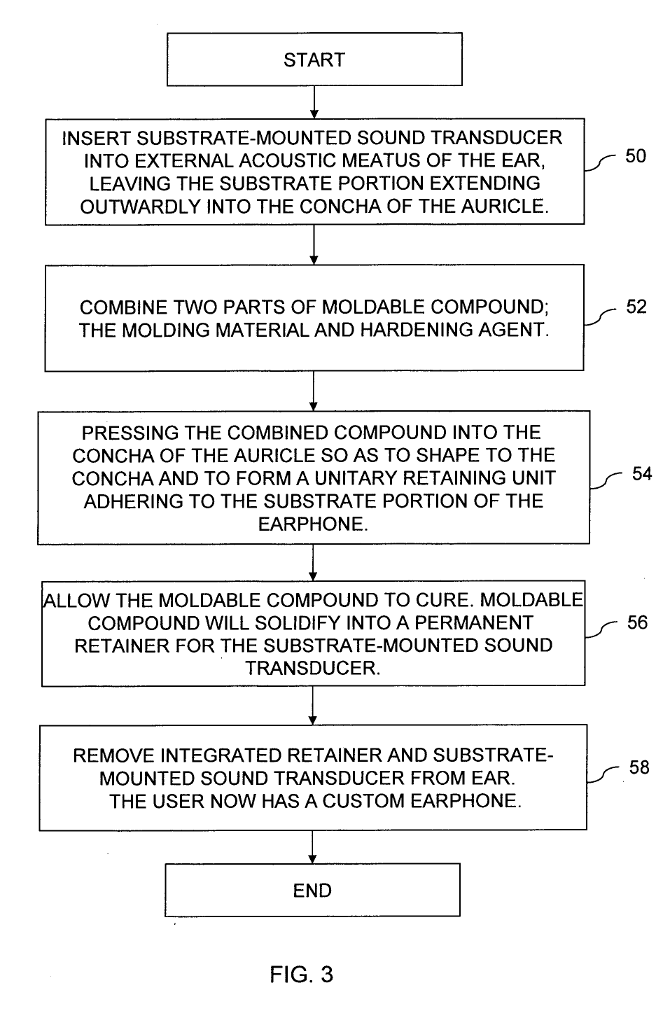

FIG. 3 is a flow chart depicting the custom earphone fabrication and fitting method of the present invention. The method can be described in five steps. In step 50 the substrate-mounted sound transducer assembly (14) is inserted into the external acoustic meatus of the ear, leaving the substrate portion (17) extending outwardly into the concha of the auricle. In step 52 the two parts of the moldable compound (22, 24) are combined. In step 54 the resulting moldable compound is pressed into the concha of the auricle so as to shape to the concha of the user and to form a unitary retainer for the substrate-mounted sound transducer assembly (14) by adhering to the substrate thereon. In step 56 the moldable compound is allowed to cure and solidify into a custom-shaped permanent retainer (12) for the substrate-mounted sound transducer. In step 58 the integrated retainer and substrate mounted sound transducer assembly (14) are removed from the ear; the custom earphone (10) is completed. If more than one earphone is desired, these steps may be repeated for each additional custom earphone.

What is claimed is:

1. An in-ear, custom-fit, self-fabricated earphone comprising,
a sound transducer for insertion into the external acoustic meatus of a human ear,
a substrate mounting the sound transducer and having an external surface, forming a sound transducer assembly,
a retainer encasing the substrate and which is molded in-situ in the concha of a human ear where the sound transducer portion of the sound transducer assembly projects laterally from the retainer, toward the external acoustic meatus.

2. The earphone of claim 1 wherein the external surface of the substrate mounting the sound transducer is silicone-adhering, and the retainer is silicone-based.

3. The method of making an earphone custom-fitted to concha of the ear comprising the steps of,
inserting the sound transducer portion of a substrate mounted earphone into the external acoustic meatus of the ear, leaving the substrate portion extending outwardly into the concha of the auricle,
combining a molding material with a hardening agent,
pressing the resulting moldable compound into the cavity and the cymba of the auricle to shape to the concha and form a unitary retainer unit so the moldable compound encompasses and adheres to the substrate portion of the earphone,
allowing the retainer forming moldable compound to cure and harden within the concha, and
removing the integrated hardened retainer and the earphone confined therein from the ear.

4. The method of claim 3 where the moldable compound is silicone-based.

5. An in-ear custom earphone kit, comprising,
at least one container containing a molding material;
at least one container containing a hardening agent, such that when the molding material and hardening agent are combined and kneaded, a resulting moldable compound is formed which may be inserted in the concha of the outer ear and allowed to harden and cure;
earphones comprised of a substrate-mounted sound transducer, said substrate being capable of adhering to the moldable compound; and
instructions for the self-fabrication and fitting of custom earphones.
